(19) United States
(12) Patent Application Publication
(10) Pub. No.: US 2022/0155092 A1
(43) Pub. Date: May 19, 2022

(54) METHOD OF NAVIGATING A VISUALLY IMPAIRED USER, A NAVIGATION SYSTEM FOR THE SAME, AND A GUIDING ROBOT

(71) Applicant: Logistics and Supply Chain MultiTech R&D Centre Limited, Pok Fu Lam (HK)

(72) Inventors: Ziqiao Lam, Pok Fu Lam (HK); Yuan Chang Jiang, Pok Fu Lam (HK); Wing Hong Wong, Pok Fu Lam (HK); Yan Nei Law, Pok Fu Lam (HK); King Sau Wong, Pok Fu Lam (HK); Yiu Man Chan, Pok Fu Lam (HK); Cheung Fong, Pok Fu Lam (HK)

(21) Appl. No.: 17/099,887

(22) Filed: Nov. 17, 2020

(51) Int. Cl. G01C 21/36; G08B 6/00; H04W 4/024; G01C 21/34; G05D 1/02; G09B 21/00

(52) U.S. Cl. CPC G01C 21/3652; G08B 6/00; H04W 4/024; G01C 21/3461; G09B 21/003; G05D 1/0259; G05D 1/0257; G05D 1/0238; G05D 1/0214

(57) ABSTRACT

A method of navigating a visually impaired user, a navigation system and a guiding robot used in the system. The method includes the steps of: receiving a plurality of location referencing signals from a plurality of signal sources; processing the location referencing signals to determine a current location of the user in a predetermined area; planning an optimal path for the user to travel from the current location to a destination location; providing guiding information associated with the optimal path to the user; obtaining a travel instruction from the user to travel along the optimal path; and moving a guiding robot according to the travel instruction provided by the user along the optimal path until the next travel instruction is required to further move the guiding robot.

### TECHNICAL FIELD

The present invention relates to a method of navigating a visually impaired user and a navigation system for the visually impaired user, and particularly, although not exclusively, to a guiding robot that guides the visually impaired user based on his travel instruction.

### BACKGROUND

A commonly used tool to present directional or guidance information to users or patrons is to use visual signage or reference points so as to communicate guidance and location information to users. However, for people with visual impairment, visual signage may not be useful or offer any significant assistance and thus there is a need for an alternative form of navigational assistance.

Tactile signage such as tactile tiles paved on floor surfaces may be one possible solution to assist visually impaired persons with navigation. These tactile signs may have a predefined shape and layout which provide a tactile feel to a user when the user steps or touches the tile. Whilst these tactile signs are helpful in providing reference information, they are limited in the assistance rendered to users.

Alternatively, some users may prefer relatively active assistances provided by guide dogs, which are professionally trained to guide the user travelling to different destinations. However, guide dogs may be usually trained to memorize only a few fixed routes and destination points, and thus limit the place that a blind person may travel by relying on the guide dogs.

### SUMMARY OF THE INVENTION

In accordance with a first aspect of the present invention, there is provided a method of navigating a visually impaired user, comprising the steps of: receiving a plurality of location referencing signals from a plurality of signal sources; processing the location referencing signals to determine a current location of the user in a predetermined area; planning an optimal path for the user to travel from the current location to a destination location; providing guiding information associated with the optimal path to the user; obtaining a travel instruction from the user to travel along the optimal path; and moving a guiding robot according to the travel instruction provided by the user along the optimal path until the next travel instruction is required to further move the guiding robot.

In an embodiment of the first aspect, the step of planning an optimal path further comprises the step of determining a path that includes a minimum number of turning as the optimal path.

In an embodiment of the first aspect, the step of obtaining a travel instruction from the user further comprises the step of obtaining a moving forward instruction or a turning left/right instruction from the user being in connection with the guiding robot.

In an embodiment of the first aspect, the method further comprises the steps of: detecting an obstacle in the optimal path; planning an alternative path for the user to travel from the current location to the destination location; and obtaining the travel instruction from the user to travel along the alternative path.

In an embodiment of the first aspect, the method further comprises the step of providing information associated with the detection of obstacle to the user.

In an embodiment of the first aspect, the method further comprises the steps of: stopping the guiding robot when the distance between the guiding robot and the obstacle exceeds a predefined threshold; and resuming the guiding robot movement when the obstacle is cleared.

In an embodiment of the first aspect, the information associated with the detection of obstacle is provided to the user by a tactile signal.

In an embodiment of the first aspect, the tactile signal includes vibration signals with different vibration patterns, frequencies and/or strengths.

In an embodiment of the first aspect, the plurality of location referencing signals includes a plurality of electromagnetic signals.

In an embodiment of the first aspect, the plurality of electromagnetic signals includes at least one of a RFID signal, Wi-Fi signal, BLE signal, and GNSS signal.

In accordance with a second aspect of the present invention, there is provided a guiding robot, comprising: one or more of signal receivers arranged to receive a plurality of location referencing signals from a plurality of signal sources; a processor arranged to process the location referencing signals to determine a current location of the user in a predetermined area, and the processor is further arranged to plan an optimal path for the user to travel from the current location to a destination location; an user interface arranged to provide guiding information associated with the optimal path to the user, and the user interface is further arranged to obtain a travel instruction from the user to travel along the optimal path; wherein the guiding robot is arranged to move according to the travel instruction provided by the user along the optimal path until the next travel instruction is required to further move the guiding robot.

In an embodiment of the second aspect, the processor is arranged to determine a path that includes a minimum number of turning as the optimal path.

In an embodiment of the second aspect, the user interface is arranged to obtain a moving forward instruction or a turning left/right instruction from the user being in connection with the guiding robot.

In an embodiment of the second aspect, the guiding robot further comprises: one or more of obstacle detectors arranged to detect an obstacle in the optimal path.

In an embodiment of the second aspect, the processor is further arranged to plan an alternative path for the user to travel from the current location to the destination location; and the user interface is further arranged to obtain the travel instruction from the user to travel along the alternative path.

In an embodiment of the second aspect, the processor is further arranged to stop the guiding robot when the distance between the guiding robot and the obstacle exceeds a predefined threshold; and the processor is further arranged to resume the guiding robot movement when the obstacle is cleared.

In an embodiment of the second aspect, the one or more of obstacle sensors includes at least one of a depth camera, a 2D LIDAR, and an mm-Wave Rader.

In an embodiment of the second aspect, the guiding robot further comprises a handle arranged to provide information associated with the detection of obstacle to the user by a tactile signal.

In an embodiment of the second aspect, the tactile signal includes vibration signals with different vibration patterns, frequencies and/or strengths.

In an embodiment of the second aspect, the plurality of location referencing signals includes a plurality of electromagnetic signals.

In an embodiment of the second aspect, the guiding robot further comprises at least one of a RFID sensor, Wi-Fi receiver, BLE receiver, and GNSS receiver to receive the plurality of electromagnetic signals.

In accordance with the third aspect of the present invention, there is provided a navigation system for a visually impaired user, comprising: a plurality of signal sources arranged to emit a plurality of location referencing signals; a guiding robot in accordance with the second aspect of the present invention, the guiding robot is arranged to receive the plurality of location referencing signals; and a handheld device arranged to provide guiding information derived by the guiding robot to the user.

In an embodiment of the third aspect, the navigation system further comprises a server including a database storing map data that is accessible by the handheld device.

In an embodiment of the third aspect, the handheld device is a smartphone or a tablet computer device.

### BRIEF DESCRIPTION OF THE DRAWINGS

Embodiments of the present invention will now be described, by way of example, with reference to the accompanying drawings in which:

FIG. 1 is a schematic diagram showing a navigation system for a visually impaired user in accordance with an embodiment of the present invention;

FIG. 2 is a schematic diagram illustrating the arrangement of the one or more of signal receivers, the processor, the user interface, and the obstacle detectors.

FIG. 3 is an illustration showing an example operation of the navigation system of FIG. 1, when a user is using a guiding robot to navigate to the destination following a path determined by the navigation system; and

FIG. 4 is an illustration showing an example operation of the navigation system of FIG. 3, when the guiding robot detects an obstacle and determine an alternative path for the user.

### DETAILED DESCRIPTION OF THE PREFERRED EMBODIMENT

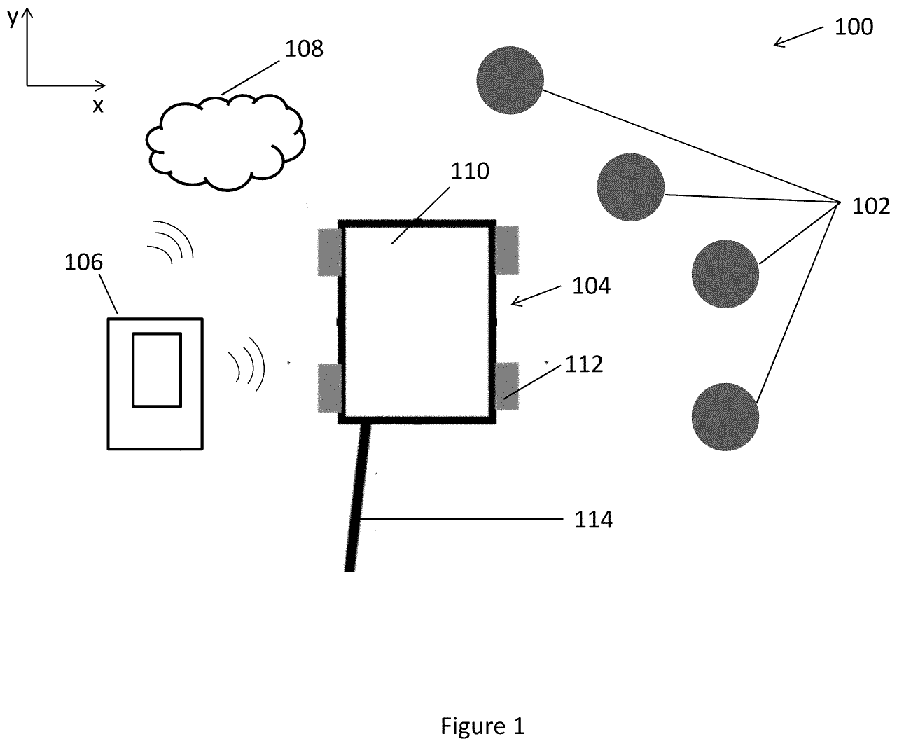

With reference to FIG. 1, there is shown an embodiment of a navigation system 100 for a visually impaired user, comprising: a plurality of signal sources 102 arranged to emit a plurality of location referencing signals; a guiding robot 104 arranged to receive the plurality of location referencing signals; and a handheld device 106 arranged to provide guiding information derived by the guiding robot 104 to the user. In navigation system 100, the plurality of signal sources 102 may be a set of signal sources that is capable of emitting a plurality of electromagnetic signals. Preferably, the plurality of electromagnetic signals may include at least one of a RFID signal, Wi-Fi signal, BLE signal, and GNSS signal. The guiding robot 104 may be arranged to use these signals to plan a navigation path for guiding the user to a desired location.

The handheld device 106 may be a smartphone or a tablet computer device in communication with the guiding robot 104 for providing the guiding information to the user. In one example, the handheld device may be in communication with the guiding robot 104 via but not limited to Bluetooth communication. The handheld device 106 may also include a user interface arranged to provide the guiding information to the user by way of for example vocal navigation.

The navigation system 100 may further include a server 108 including a database storing map data. Preferably, the database may be accessible by the handheld device 106 such that the guiding information derived by the guiding robot 104 may be combined with the map data to provide the guiding information in a presentable form to the user.

In this embodiment, the guiding robot 104 may be a guiding vehicle or a guide dog. The guiding robot 104 has a vehicle body 110 with four wheels 112 operably connected to the vehicle body 110, so as to drive the guiding robot 104 to move along a surface, such as a ground surface. The guiding robot 104 also includes a handle 114 which may be held by a user, such that the guiding robot 104 may navigate and guide the user to move from one position to another.

The wheels 112 are provided for facilitating a smooth movement of the guiding robot 104. Preferably, at least one pair of the wheels (i.e. at least the front wheel pair or the rear wheel pair) may be motorized such that the wheels may be steered in different angles for turning around a corner or an obstacle. In particular, the wheels 112 may be stopped immediately by brakes when the guiding robot 104 is too close to an obstacle, such as in the case that the distance between the guiding robot 104 and the obstacle exceeds a predefined threshold value.

The handle 114 may also be arranged to allow the user to provide a travel instruction to the guiding robot 104 so as to travel a predetermined path and/or to provide information associated with a detection of obstacle to the user. Details regarding to this aspect will be discussed later.

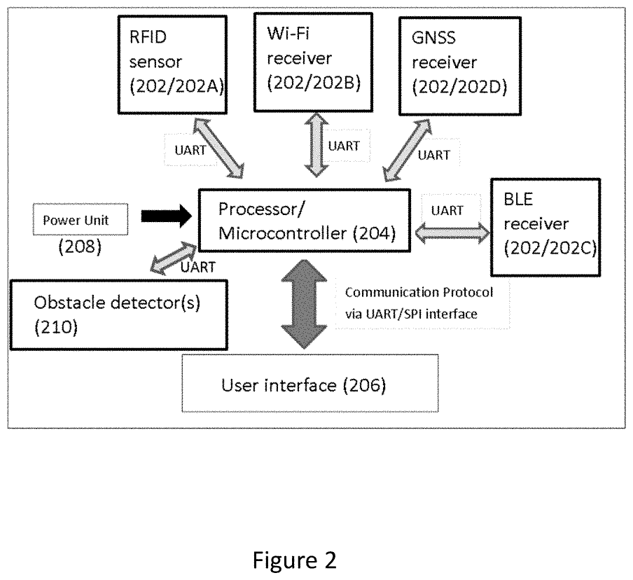

With reference to FIG. 2, the guiding robot 104 may include one or more of signal receivers 202 arranged to receive a plurality of location referencing signals from a plurality of signal sources. In particular, the one or more of signal receivers 202 is operably connected with a processor/microcontroller 204. The processor 204 may be arranged to process the location referencing signals to determine a current location of the user in a predetermined area, and may be further arranged to plan an optimal path for the user to travel from the current location to a destination location.

The guiding robot 104 may also include a user interface 206 operably connected with the processor 204. The user interface 206 may be arranged to provide guiding information associated with the optimal path to the user, and may be further arranged to obtain a travel instruction from the user to travel along the optimal path. In this way, the guiding robot 104 may be arranged to move according to the travel instruction provided by the user along the optimal path until the next travel instruction is required to further move the guiding robot 104. The guiding robot may further include a power unit 208 to power the processor operation.

In this example, the guiding robot 104 may include one or more of signal receivers 202, each of which may be responsible for receiving a plurality of electromagnetic signals and providing the received signal to the processor for further processing. For example, referring to FIG. 2, the guiding device may include a RFID sensor 202A, a Wi-Fi receiver 202B, a BLE receiver 202C, and a GNSS receiver 202D operably connected with the processor 204 via UART, each of the sensor/receiver may be arranged to receive a particular type of electromagnetic signal and provide such signal for the processor 204 for further processing.

After receiving the necessary location referencing signals from the one or more of signal receivers 202, the processor 204 may then be able to determine a current location of the user with reference to the received location referencing signals, and plan an optimal path for the user to travel from the current location to the destination. Preferably, the processor 204 may include an algorithm to determine a path that includes a minimum number of turning as the optimal path such that the user may be guided to move as straight as possible prior to reaching the destination.

Once the optimal path is determined, the processor may provide the user the guiding information associated with the optimal path through the user interface 206. In this example, the user interface 206 may be operably connected with the processor via UART/SPI interface. The user interface may include a control panel operably connected with the handle 114, and include a mobile application (app) running on the handheld device 106. In particular, the handheld device 106 may be in communication with the processor 204 via the BLE receiver 202C of the guiding robot 104 such that the guiding information may be transmitted to the handheld device 106, and may be provided to the user by audio signals such as vocal navigation. Meanwhile, the processor 204 may further request the user to provide a travel instruction to allow the user to decide whether to proceed with the optimal path as suggested by the guiding robot 104.

In response, the user may use the control panel to provide the travel instruction to the guiding robot 104.

The control panel may be in form of physical directional buttons, joystick, control knob and the like operably connected with the handle 114. In operation, the user may simply use his thumb to press a button representing a particular direction or move the joystick/control knob to the particular direction to provide the travel instruction to the guiding robot 104. For example, in case the control panel is in form of physical directional buttons, the user may provide a moving forward instruction by pressing a forward button or a turning left/right instruction by pressing a left/right button. Optionally or additionally, the user may provide a stop travelling instruction to the guiding robot 104 by pressing a backward button. Alternatively, the user may provide a vocal travel instruction to the guiding robot 104 through the handheld device 106.

Upon receiving the travel instruction, the processor 202 may signal the motor of the guiding robot 104 to activate and drive the guiding robot 104 to move unless it is required a next travel instruction to proceed. For example, the guiding robot 104 may keep moving forward in response to a moving forward instruction given by the user, unless there is a requirement to provide a turning left/right instruction in the occasions such as turning around a corner or detection of an obstacle.

The guiding robot 104 may further include one or more of obstacle detectors 210 arranged to detect an obstacle in the optimal path. The one or more of obstacle detectors 210 may be operably connected with the processor 204 by way of such as UART, such that the obstacle signals received by the obstacle detector(s) may be provided to the processor 204 for further processing. In particular, the one or more obstacle detectors 210 may include at least one of a depth camera, a 2D LIDAR, and an mm-Wave Rader arranged to detect irregular shape, height, depth, and movement of objects in the optimal path.

In one example, the guiding robot 104 may include a depth camera arranged to capture frontal 3D view of the guiding robot 104 so as to detect objects with irregular shape and any objects at head height, a 2D LIDAR for capturing a 360° planar view around the guiding robot 104 for detecting walls, and an mm-Wave Radar for detecting any moving object such as vehicles and pedestrians. In particular, data from the depth camera and the 2D LIDAR may be combined for constructing an occupancy grid.

The detected obstacle signals may be gathered by the processor 204, and then the processor 204 may plan an alternative path for the user to travel from the current location to the destination. In particular, the processor 204 may plan the alternative path based on some obstacle avoidance algorithm such as elastic band or further in combination with the previously mentioned “as straight as possible” algorithm.

Similarly, the processor 204 may provide the information associated with the alternative path to the user through the user interface 206 such as the handheld device 106 running the mobile app and request the user to provide the travel instruction to travel along the alternative path. Meanwhile, the processor 204 may provide the information associated with the detection of obstacle to the user in form of a tactile signal. In one example, the tactile signal may be provided to the user through the handle 114 of the guiding robot 104. The handle 114 may include or connected with a vibration generator such that the tactile signal may be provided to the user with different vibration patterns, frequencies and/or strengths.

Preferably, the differences of vibration patterns frequencies and/or strengths may represent the size, distance, or types of the detected object/obstacle. For example, the tactile signal may be provided to the user with an increasing strength and/or frequency when the guiding robot 104 is getting closer and closer to the obstacle. In addition, tactile signals of different vibration patterns may be provided to the user to represent the detection of a stationary object and moving object respectively.

As mentioned, the guiding robot 104 may keep moving forward unless there is a requirement to provide a turning left/right instruction in occasions such as turning around a corner or detection of an obstacle. Thus, in case the user fails to provide such travel instruction, the processor 204 may keep informing the user for the detection of obstacle and keep requesting the user to provide said travel instruction.

Meanwhile, the one or more of obstacle detectors 210, such as the mm-Wave Radar may measure the distance between the guiding robot 104 and the obstacle to determine if the distance exceeds a predefined threshold value, thereby determining whether to stop the guiding robot 104. For example, the one or more of obstacle detectors 210 may keep determining the distance between the guiding robot 104 and an obstacle within 50 meters from the guiding robot. If the distance is found to be lower than a certain meters such as 5 meters, the processor 204 may signal the brakes of the guiding robot 104 to activate and stop the robot accordingly. Optionally or additionally, the one or more of obstacle detectors 210 may also detect velocity of a moving object to evaluate the level of danger of the object toward the user. Until there is no obstacle signals detected by the one or more of obstacle detectors 210 (i.e. the obstacle is cleared), the processor 204 may signal the brake to deactivate as well as signal the motor to activate to resume the movement of the guiding robot 104.

In contrast, if the user provided the travel instruction before the predefined threshold exceeds, the processor 204 may then arrange the guiding robot 104 to move along the alternative path according to the user's instruction. In particular, the processor 204 may include an algorithm that requires the guiding robot 104 not to turn left/right immediately. Preferably, the processor 104 may include an algorithm that requires the processor to determine a path that guides the user to make a turn in a corner.

Advantageously, it may provide a safeguard measure to the user when the user is navigated. For example, it is appreciated that in some occasions there may be some blind spots within the operation area which may cause a precision error to the navigation system, or in some other occasions the user may accidentally provide a wrong travel instruction to the guiding robot, such that in either cases the user may turn left/right too early, which may eventually cause the user to collide with an obstacle/wall or even worse if the obstacle is a highway which could cause fatal accident. With the use of the aforementioned obstacle detectors as well as the processor, the processor of the guiding robot may determine whether it is a correct time to turn left/right based on the information received by the obstacle detectors as well as the processor algorithm such that the chance of the user getting hurt as a result of the aforesaid error can be minimized.

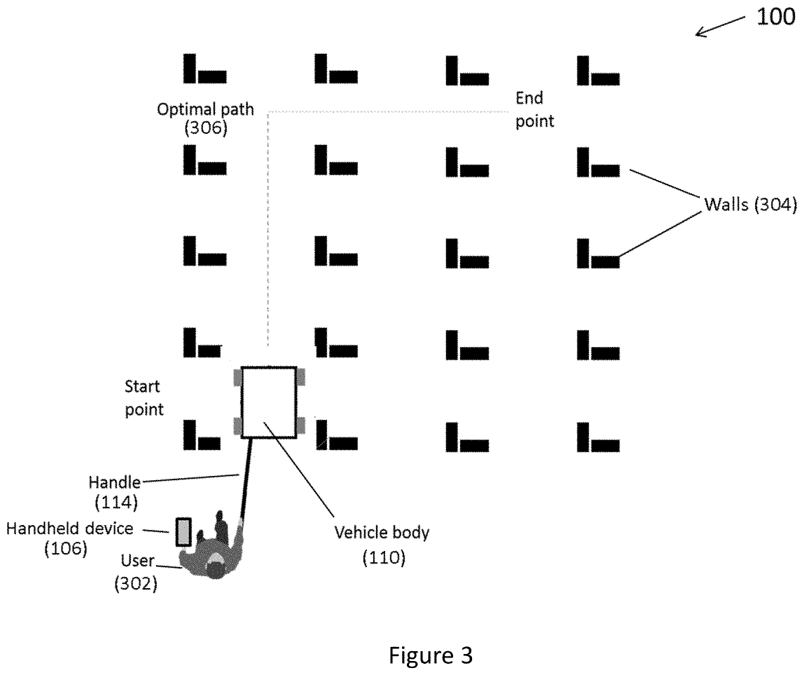

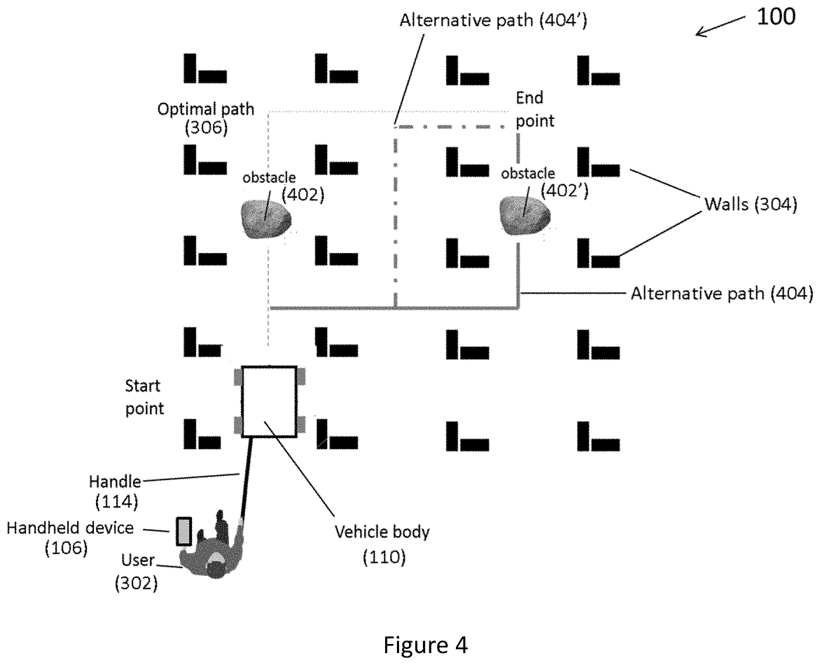

With reference to FIGS. 3 and 4, there is shown an example operation of the navigation system 100 being used by a visually impaired user 302 in a predetermined area. The navigation system 100 may be used to guide the user 302 from one position to a destination.

In this example, the navigation system 100 comprises a plurality of signal sources (not shown) emitting at least one of at least one of a RFID signal, Wi-Fi signal, BLE signal, and GNSS signal as a plurality of location referencing signals.

The navigation system 100 also comprises a guiding robot 104 arranged to receive and process the plurality of location referencing signals so as to derive guiding information for the user 302. The guiding robot 104 may include a vehicle body 110 with four motorized wheels 112. The vehicle body 110 may move around the area defined by a plurality of walls 304. Extended from the vehicle body 110, there is provided a (rear) handle 114 which may be held by the user 302 when being used.

The handle 114 may include or connect to a vibration generator for providing tactile signals to the user 302 holding the handle 114. Preferably, the tactile signals include vibration signals with different vibration patterns, frequencies and/or strengths, which may represent different guiding information to be provided to the user 302. The handle 114 may also vibrate at different frequencies that indicate different situations. The handle 114 may also include a plurality of physical buttons thereon as a user interface 206 for the user to provide travel instruction to the guiding robot 104.

The navigation system 100 may also include a handheld device 106 such as a mobile phone arranged to provide guiding information derived by the guiding robot 104 to the user. Preferably, the handheld device 106 may be in communication with the guiding robot 104 via Bluetooth communication. The handheld device 106 may also be installed with a navigation mobile application (app) such that the guiding information may be provided to the user 302 by way of for example vocal navigation hints and information.

The navigation system 100 may further include a server (not shown) including a database storing map data. Preferably, the database may be accessible by the handheld device 106 such that the guiding information derived by the guiding robot 104 may be combined with the map data to provide the guiding information in a presentable form to the user 302.

The guiding robot 104 may include a navigation control module (NCM) within its body 110, arranged to receive and process the plurality of location referencing signals. In particular, the NCM may include a RFID sensor 202A, a Wi-Fi receiver 202B, a BLE receiver 202C, and a GNSS receiver 202D operably connected with the processor 204 via UART, each of the sensor/receiver may be arranged to receive a particular type of electromagnetic signal and provide such signal for the processor 204 for further processing. For example:

The RFID sensor 202A is responsible for reading signals from passive RFID tags so as to provide RFID tag numbers to the processor 204;

The Wi-Fi receiver 202B is responsible for scanning the surrounding Wi-Fi signatures from Wi-Fi access point so as to provide coordinate information to the processor 204;

The BLE receiver 202C is responsible for scanning the surrounding BLE beacons information and provide BLE signals received from the beacons to the processor 204 for location calculation; and

The GNSS receiver 202D is responsible for receiving GNSS signals from multiple GNSS system such as GLONASS, GPS, BeiDou and the like so as to provide a real time position signal to the processor 204.

The processor 204 may then determine a current location of the user 302 with reference to the received location referencing signals, and plan an optimal path 306 for the user 302 to travel from the current location to the destination. As mentioned, the processor 204 may include an algorithm to determine a path that includes a minimum number of turning as the optimal path 306 such that the user 302 may be guided to move as straight as possible prior to reaching the destination. For example, as shown in FIG. 3, the processor may make reference to the objects located by the left and right side of the guiding robot 104 to determine the optimal path. Preferably, the processor may continuously make such reference so as to update the optimal path continuously. In this case, the processor 204 may make reference to the walls 304 located on the left and right side of the guiding robot 104 to determine the optimal path 306, which is composed of two straight paths joining at a corner. In this way, the user 302 is guided to turn around one corner only prior to reaching the destination.

In an alternative example, the processor 204 may simply gather the location referencing information received from the plurality of signal receivers 202 and transmit the location referencing information to the handheld device 106 for determining the optimal path 306. In particular, the navigation mobile (app) installed on the handheld device 106 may be arranged to plan the optimal path 306 based on the map data obtained from the server database in combination with the algorithm as mentioned above.

Once the optimal path 306 is determined, the guiding information associated with the optimal path may be provided to the user 302 by vocal navigation hints and information through the handheld device 106. For example, the handheld device may provide hints to the user 302 for shops/buildings nearby, estimated length for a portion of or the whole optimal path, estimated time for finishing the portion of or the whole path, etc.

The user 302 may then provide a travel instruction to the guiding robot 104 such that the guiding robot may move along the optimal path 306 according to the instruction until the next travel instruction is required. Referring to FIG. 3, the user 302 may provide a moving forward instruction to the guiding robot 104 by pressing a forward button once. In this way, the guiding robot 104 may keep moving forward until reaching the corner of the optimal path 306. Upon reaching the corner, the guiding robot 104 may stop and the user 302 may provide the next travel instruction to the guiding robot 104 to move further, which in this case by pressing a right button on the handle 114 once such that the guiding robot 104 may turn around the corner. Alternatively, if the user 302 pressed the right button prior to reaching the corner, the guiding robot 104 will not turn right immediately until it founds a corner to turn. After turning, the user 302 may again provide a moving forward instruction to the guiding robot 104 to move to the destination.

The guiding robot 104 may further include a vision module 210 for detecting obstacle along the optimal path 306. The vision module 210 may include a depth camera, a 2D LIDAR, and an mm-Wave Rader. As mentioned, each of which may be arranged to capture frontal 3D view and a 360° planar view, and detect any moving object so as to determine if there is an obstacle on the optimal path 306. The processor 204 may then plan an alternative path for the user 302 to travel from the current location to the destination based on the obstacle signals received.

Referring to FIG. 4, there is an obstacle 402 located on the optimal path 306. In this example, the obstacle 402 may be located from 50 meters away from the guiding robot. The vision module 210 may detect the obstacle 402 and provide an obstacle signal to the processor 204 that there is an obstacle on the optimal path 306. The processor 204 may then plan an alternative path for the user 302 to get around the obstacle 402.

In particular, the guiding robot 104 may interact with the local environment upon planning the alternative path such as detecting any other obstacles nearby, using the depth camera and the 2D LIDAR to create an occupancy grip for the operation area. The processor 204 may therefore determine an (optimal) alternative path for the user 302 to travel. For example, referring to FIG. 4, without the detection of the nearby obstacle 402′, the processor would have planned an alternative path 404 as a result of the previously mentioned “as straight as possible” algorithm, which would lead user to the obstacle 402′ and eventually the user may have to route a much longer distance to reach the destination. In contrast, with the creation of occupancy grip, the processor may then be able to plan the (optimal) alternative path 404′ for the user 302 to travel to the destination.

The guiding robot may then inform the user 302 for the information associated with the alternative path 404 through the handheld device 106 running the navigation mobile app. The handheld device 106 may provide a vocal navigation hints and information for the alternative path 404 to the user 302. Optionally or additionally, the handheld device 106 may also inform the user 302 for the detection of obstacle ahead by for example vocal navigation. Meanwhile, the handle 114 may start vibrating upon the detection of obstacle 402, so as to provide a tactile signal to the user 302 for the detection. The tactile signal may also serve as an alert or reminder for the user 302 to provide the next travel instruction to the guiding robot 104 so as to move along the alternative path 404.

As mentioned, without the provision of a further travel instruction to the guiding robot 104, the guiding robot may keep moving forward, which for example, as shown in FIG. 4, the guiding robot 104 may keep moving towards the obstacle 402. To prevent the user 302 from colliding with the obstacle 402, the mm-Wave Radar of the guiding robot 104 may measure the distance between the obstacle 402 and the guiding robot 104, and if the distance exceeds a certain threshold value, the guiding robot 104 may be stopped immediately by brakes on the motorized wheels. The guiding robot 104 may resume its movement when the obstacle 402 is cleared.

In contrast, if the user 302 provides the travel instruction before the predefined threshold value exceeds, the guiding robot 104 may then turn right to move along the alternative path 404 (as shown in FIG. 4). Preferably, the guiding robot 104 may not turn right immediately upon receiving the user's turning right instruction. The processor 204 of the guiding robot 104 may include an algorithm that guides the guiding robot to search for a corner, so as to make sure that the guiding robot 104 will make a turn in a corner and will not make a turn too early due to for example precision error to the navigation system or instruction error made by the user as discussed previously.

These embodiments may be advantageous in that interactive guiding robot can provide accurate navigation information to a blind user which may be similar to relying on a guide dog, so that the user can readily switch to use a new interactive navigation system.

Advantageously, the navigation system of the present invention may provide the user a high degree of control on the path he may travel along such that the user may have a better user experience. For example, the optimal path provided by the system may serve as a reference to the user, the user may actually choose not to follow such path and provide an alternative travel instruction to the system so as to travel along an alternative path instead. The user may also interrupt the navigation system of the present invention anytime upon travelling on the optimal path by providing stopping instruction or a turning left/right instruction to the system.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method of navigating a visually impaired user, comprising the steps of:
receiving a plurality of location referencing signals from a plurality of signal sources;
processing the location referencing signals to determine a current location of the user in a predetermined area;
planning an optimal path for the user to travel from the current location to a destination location;
providing guiding information associated with the optimal path to the user;
obtaining a travel instruction from the user to travel along the optimal path; and
moving a guiding robot according to the travel instruction provided by the user along the optimal path until the next travel instruction is required to further move the guiding robot.

2. The method of claim 1, wherein the step of planning an optimal path further comprising the step of determining a path that includes a minimum number of turning as the optimal path.

3. The method of claim 1, wherein step of obtaining a travel instruction from the user further comprising the step of obtaining a moving forward instruction or a turning left/right instruction from the user being in connection with the guiding robot.

4. The method of claim 1, further comprising the steps of:
detecting an obstacle in the optimal path;
planning an alternative path for the user to travel from the current location to the destination location; and
obtaining the travel instruction from the user to travel along the alternative path.

5. The method of claim 4, further comprising the step of providing information associated with the detection of obstacle to the user.

6. The method of claim 4, further comprising the steps of:
stopping the guiding robot when the distance between the guiding robot and the obstacle exceeds a predefined threshold; and
resuming the guiding robot movement when the obstacle is cleared.

7. The method of claim 5, wherein the information associated with the detection of obstacle is provided to the user by a tactile signal.

8. The method of claim 7, wherein the tactile signal includes vibration signals with different vibration patterns, frequencies and/or strengths.

9. The method of claim 1, wherein the plurality of location referencing signals includes a plurality of electromagnetic signals.

10. The method of claim 9, wherein the plurality of electromagnetic signals includes at least one of a RFID signal, Wi-Fi signal, BLE signal, and GNSS signal.

11. A guiding robot, comprising:
one or more of signal receivers arranged to receive a plurality of location referencing signals from a plurality of signal sources;
a processor arranged to process the location referencing signals to determine a current location of the user in a predetermined area, and the processor is further
arranged to plan an optimal path for the user to travel from the current location to a destination location;
an user interface arranged to provide guiding information associated with the optimal path to the user, and the user interface is further arranged to obtain a travel instruction from the user to travel along the optimal path;
wherein the guiding robot is arranged to move according to the travel instruction provided by the user along the optimal path until the next travel instruction is required to further move the guiding robot.

12. The guiding robot of claim 11, wherein the processor is arranged to determine a path that includes a minimum number of turning as the optimal path.

13. The guiding robot of claim 11, wherein the user interface is arranged to obtain a moving forward instruction or a turning left/right instruction from the user being in connection with the guiding robot.

14. The guiding robot according to claim 11, further comprising:
one or more of obstacle detectors arranged to detect an obstacle in the optimal path.

15. The guiding robot according to claim 14, wherein the processor is further arranged to plan an alternative path for the user to travel from the current location to the destination location; and the user interface is further arranged to obtain the travel instruction from the user to travel along the alternative path.

16. The guiding robot according to claim 14, wherein the processor is further arranged to stop the guiding robot when the distance between the guiding robot and the obstacle exceeds a predefined threshold; and the processor is further arranged to resume the guiding robot movement when the obstacle is cleared.

17. The guiding robot according to claim 14, wherein the one or more of obstacle sensors including at least one of a depth camera, a 2D LIDAR, and an mm-Wave Rader.

18. The guiding robot according to claim 14, further comprising a handle arranged to provide information associated with the detection of obstacle to the user by a tactile signal.

19. The guiding robot of claim 18, wherein the tactile signal includes vibration signals with different vibration patterns, frequencies and/or strengths.

20. The guiding robot according to claim 11, wherein the plurality of location referencing signals includes a plurality of electromagnetic signals.

21. The guiding robot according to claim 20, further comprising at least one of a RFID sensor, Wi-Fi receiver, BLE receiver, and GNSS receiver to receive the plurality of electromagnetic signals.

22. A navigation system for a visually impaired user, comprising:
a plurality of signal sources arranged to emit a plurality of location referencing signals;
a guiding robot in accordance with claim 11 arranged to receive the plurality of location referencing signals; and
a handheld device arranged to provide guiding information derived by the guiding robot to the user.

23. The navigation system according to claim 22, further comprising a server including a database storing map data that is accessible by the handheld device.

24. The navigation system according to claim 21, wherein the handheld device is a smartphone or a tablet computer device.
